(19) United States
(12) Patent Application Publication
(10) Pub. No.: US 2026/0134164 A1
(43) Pub. Date: May 14, 2026

(54) ROTOR CORE DESIGN METHOD

(71) Applicants: Aisin Corporation, Kariya (JP); National University Corporation, Nagasaki University, Nagasaki City (JP)

(72) Inventors: Yoshitsugu OTOMO, Nagasaki-shi (JP); Masako Shibamori, Kariya-shi (JP); Teppei Tsuda, Kariya-shi (JP); Yushi Kido, Kariya-shi (JP)

(73) Assignees: Aisin Corporation, Kariya (JP); National University Corporation, Nagasaki University, Nagasaki City (JP)

(21) Appl. No.: 19/374,582

(22) Filed: Oct. 30, 2025

(30) Foreign Application Priority Data
Nov. 12, 2024 (JP) 2024-197705

(51) Int. Cl. G06F 30/17; G06F 30/23; G06F 119/14

(52) U.S. Cl. CPC G06F 30/17; G06F 30/23; G06F 2119/14

(57) ABSTRACT

A rotor core design method for designing a shape of a rotor core including a magnet arrangement region where a permanent magnet is arranged and a flux barrier region that limits a flow of a magnetic flux includes: when determining a core cross-sectional shape, which is a shape of a cross section orthogonal to a rotation axis of the rotor core, by topology optimization using a finite element method, arranging a plurality of Gaussian bases in a design target region, and defining a shape function by superimposing Gabor filters at wavelengths individually set for the plurality of Gaussian bases; and determining the core cross-sectional shape satisfying a preset objective condition by using the shape function according to an optimization algorithm.

### CROSS REFERENCE TO RELATED APPLICATIONS

This application is based on and claims priority under 35 U.S.C. § 119 to Japanese Patent Application 2024-197705, filed on Nov. 12, 2024, the entire content of which is incorporated herein by reference.

### TECHNICAL FIELD

This disclosure relates to a rotor core design method.

### BACKGROUND DISCUSSION

To design a shape of a rotor core, a core cross-sectional shape may be determined by topology optimization using a finite element method. Although there are various methods for topology optimization, an on/off method can be suitably used in that a search independent of an initial value is possible.

An example of topology optimization by the on/off method is disclosed in Takahiro Sato and 5 others, “Shape Optimization of Rotor in Interior Permanent Magnet Motor Based on Topology Optimization Method Using Normalized Gaussian Network”, IEEJ Transactions on Industry Applications, 2015, Vol. 135, No. 3, pp. 291-298 (Non-Patent Literature 1). In Non-Patent Literature 1, a shape function is defined by superimposing normalized Gaussian functions that spatially change smoothly, and an on/off state is given to each cell according to positive or negative outputs of the shape function, so that a rotor core having a smooth shape can be formed.

However, in the method disclosed in Non-Patent Literature 1, although a smooth shape is formed, there is a disadvantage that a global shape is formed because on/off determination is performed on a uniform Gaussian base function distribution. Therefore, for example, it is difficult to express a fine shape having a slit shape, and it is not suitable to design a shape of a rotor core of an embedded magnet synchronous motor that utilizes a reluctance torque in addition to a magnet torque.

A need thus exists for a rotor core design method which is not susceptible to the drawback mentioned above.

### SUMMARY

According to an aspect of this disclosure, there is provided a rotor core design method for designing a shape of a rotor core including a magnet arrangement region where a permanent magnet is arranged and a flux barrier region that limits a flow of a magnetic flux, the rotor core design method including:
when determining a core cross-sectional shape, which is a shape of a cross section orthogonal to a rotation axis of the rotor core, by topology optimization using a finite element method,
arranging a plurality of Gaussian bases in a design target region and defining a shape function by superimposing Gabor filters at wavelengths individually set for the plurality of Gaussian bases; and
determining the core cross-sectional shape satisfying a preset objective condition by using the shape function according to an optimization algorithm.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view illustrating an embedded magnet synchronous motor according to an embodiment;

FIG. 2 is an image view illustrating a design target region where a plurality of Gaussian bases are arranged;

FIG. 3 is an image view illustrating how wavelengths of Gabor filters are individually set for Gaussian bases;

FIG. 4 is a view illustrating a core cross-sectional shape obtained by an NGnet method;

FIG. 5 is a view illustrating a core cross-sectional shape obtained by a basic Gabor filter method;

FIG. 6 is a view illustrating a core cross-sectional shape obtained by an improved Gabor filter method;

FIG. 7 is a view illustrating a relationship between a wavelength for each Gaussian base and a miniaturization level of a core cross-sectional shape;

FIG. 8 is a schematic view illustrating an example of mesh division in the design target region; and

FIG. 9 is a schematic view illustrating an example of mesh division smoothed at a material boundary in the design target region.

### DETAILED DESCRIPTION

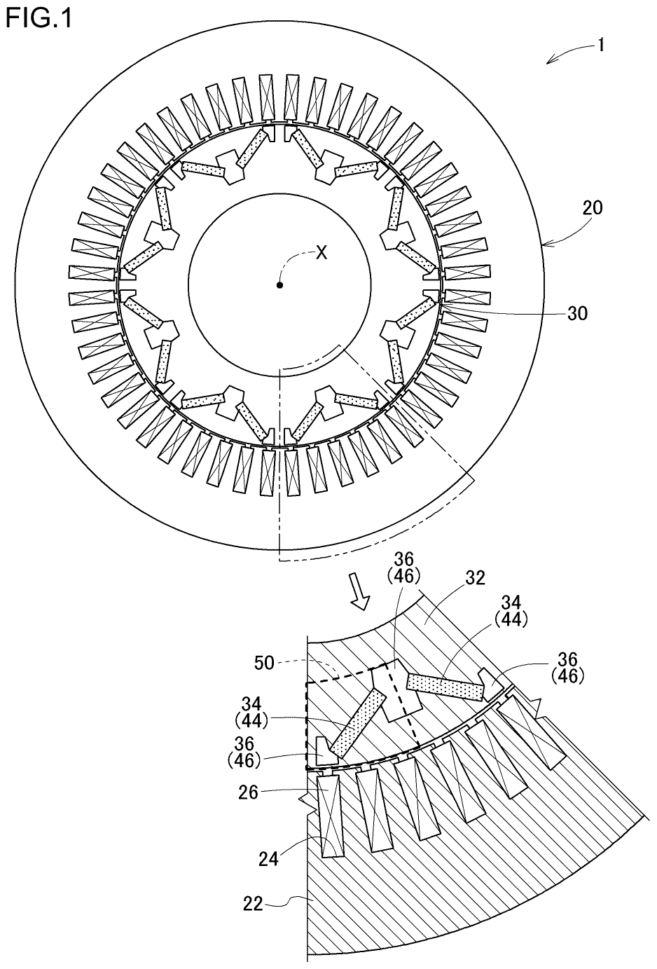

An embodiment of a rotor core design method will be described with reference to the drawings. The rotor core design method according to the present embodiment is a method for designing a shape of a rotor core 32 of a rotor 30 in an embedded magnet synchronous motor 1 as illustrated in FIG. 1.

As illustrated in FIG. 1, the embedded magnet synchronous motor 1 includes a stator 20 and the rotor 30 that faces the stator 20. The stator 20 is fixed to a non-rotating member such as a base or a housing. The rotor 30 is disposed radially inside the stator 20 and is supported in a manner of being rotatable relative to the stator 20.

The stator 20 includes a stator core 22 having a plurality of slots 24, and coils 26 disposed in the slots 24 and wound around the stator core 22. The embedded magnet synchronous motor 1 may be, for example, a three-phase AC motor, and in this case, the coils 26 include, for example, three types of phase coils including a U-phase coil, a V-phase coil, and a W-phase coil. A winding method of the coil 26 (each phase coil) is not particularly limited, and may be either concentric winding or distributed winding, and may be either wave winding or lap winding. The number of the slots 24 is not particularly limited, and is determined according to the number of phases and the number of magnetic poles of the coils 26.

The rotor 30 includes the rotor core 32 and permanent magnets 34 fixed in the rotor core 32. In the present embodiment, one magnetic pole is formed by a pair of two permanent magnets 34 arranged in a V-shape, and a pair of permanent magnets 34 forming an S pole and a pair of permanent magnets 34 forming an N pole are alternately arranged in a peripheral direction. The rotor 30 includes flux barriers 36 that limit a flow of a magnetic flux at both ends of the permanent magnet 34. Although the flux barrier 36 is implemented by a gap in the present embodiment, the flux barrier 36 may be implemented by, for example, a resin, a varnish, and an adhesive filled in the gap.

In the present embodiment, a magnet arrangement region 44 is formed by a hole into which the permanent magnet 34 is inserted. A flux barrier region 46 is formed by the gap for forming the flux barrier 36. In this manner, the rotor core 32 includes the magnet arrangement region 44 where the permanent magnet 34 is arranged and the flux barrier region 46 that limits a flow of a magnetic flux.

In a rotor core design method according to the present embodiment (hereinafter referred to as the “present design method”), a shape of a cross section of the rotor core 32 orthogonal to a rotation axis X (hereinafter referred to as a “core cross-sectional shape”) is determined by topology optimization using a finite element method. The “shape” in the core cross-sectional shape is a shape of a portion (a portion formed of a magnetic material) mainly serving as a magnetic path, and the portion serving as a magnetic path may include a bridge portion. Hereinafter, the outline of the method will be briefly described, and then definition of a shape function serving as the core will be described in comparison with other examples.

The present design method includes a design target region setting step, a mesh forming step, a shape deriving step, and an optimization step.

In the design target region setting step, a design target region 50 is set in a region including the magnet arrangement region 44 and the flux barrier region 46 in the rotor core 32. In the present embodiment, as illustrated in FIG. 1, a shape of the rotor core 32 is rotationally symmetric (8-fold symmetric in the illustrated example), and each magnetic pole (the pair of permanent magnets 34 arranged in the V-shape) is plane-symmetric with respect to the center in the peripheral direction. In consideration of such symmetry, a half region of each magnetic pole is set as the design target region 50 in the present embodiment. Further, in the present embodiment, in the half region of each magnetic pole in the rotor core 32, a region excluding an inner diameter side portion fitted to a rotor axis and a rotor surface facing the stator 20 (in other words, facing the air gap) is set as the design target region 50.

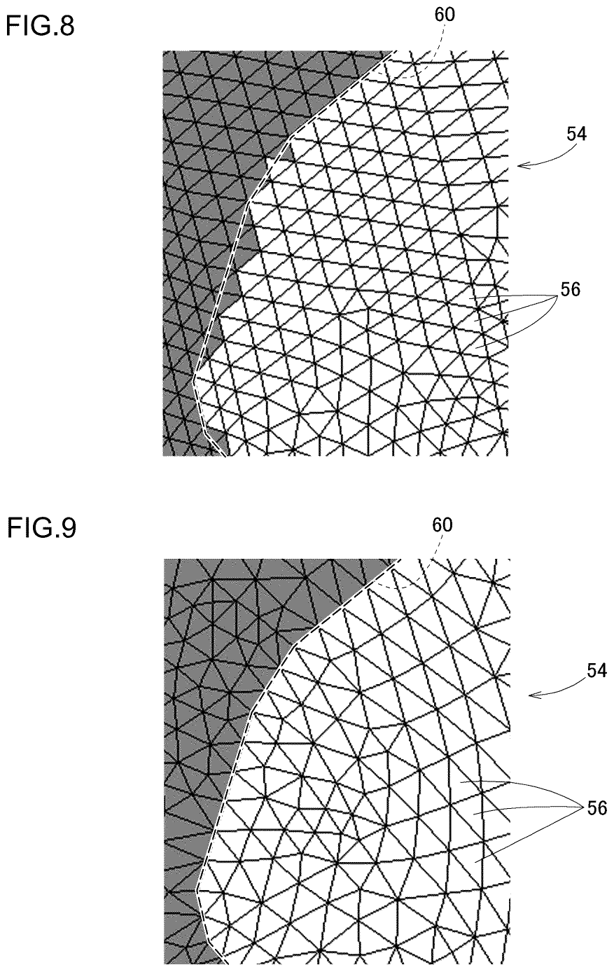

In the mesh forming step, the design target region 50 is divided into meshes to create meshes 54 including a set of a large number of minute elements (cells 56) (see FIG. 8). Although FIG. 8 illustrates an example in which triangular meshes are created, a shape of the mesh 54 is not particularly limited, and a mesh having another shape such as a quadrangular mesh may be created.

In the shape deriving step, a material distribution of the cells 56 included in the meshes 54 of the design target region 50 is determined, and an overall shape in the region is derived. That is, the overall shape is derived by assigning a material type to each cell 56. In the present embodiment, it is determined whether to dispose a magnetic material (for example, an iron-based material such as electromagnetic steel or ferrite) or a non-magnetic material (for example, air) in each cell 56, and the overall shape of the design target region 50 in the rotor core 32 is derived as a sum of the cells 56. In the example of FIG. 8, the cells 56 in which the magnetic material is disposed are colored, and a shape of the rotor core 32 is determined by a set of such cells 56. The cells 56 that are not colored are cells in which the magnetic material is not disposed, and the flux barrier region 46 is formed by a set of such cells 56.

A material type can be assigned to each cell 56 by defining a shape function that covers the design target region 50 and determining whether an output (that is, a value of the shape function) is positive or negative. For example, the magnetic material is assigned to the cell 56 in which the value of the shape function is positive or zero, and the non-magnetic material is assigned to the cell 56 in which the value of the shape function is negative. Here, since the shape of the rotor core 32 is determined based on a material distribution of the cells 56 and the material distribution of the cells 56 is determined based on the output of the shape function, how to define the shape function is very important to obtain a desirable core cross-sectional shape. The definition of the shape function will be described later.

The shape of the rotor core 32 determined based on the material distribution of the cells 56 in one time shape deriving step is one candidate for a desirable core cross-sectional shape. A plurality of (a large number of) candidates of the desired core cross-sectional shape are derived by repeatedly executing the shape deriving step.

In the optimization step, the core cross-sectional shape is optimized in relation to a preset objective condition based on the candidates of the core cross-sectional shape derived in the shape deriving step. Here, the objective condition is a condition that defines desirable features related to the embedded magnet synchronous motor 1 including the rotor core 32. The objective condition includes, for example, increasing an outputtable torque, increasing a torque density, reducing a torque ripple, and improving a strength against a centrifugal force. The objective condition may be a combination of two or more of the conditions, and in the case of a combination, a priority may be assigned.

It is needless to say that “optimization” in the present embodiment does not necessarily mean that a most suitable single core cross-sectional shape is determined. When there is only one objective condition, there is usually only one optimal solution, and it is optimal to obtain the optimal solution. On the other hand, when two or more objective conditions are combined as described above, since there are generally a plurality of Pareto optimal solutions having a trade-off relationship with each other, it is optimal to obtain a Pareto frontier and select a specific rate optimal solution from the Pareto frontier.

In the optimization step, an objective function corresponding to the objective condition is set, and the core cross-sectional shape is determined such that a value of the objective function is maximized (or minimized). When a plurality of (a large number of) candidates of the core cross-sectional shape are derived in the shape deriving step repeatedly executed as described above, the value of the objective function is calculated using candidate shapes as an input. A candidate shape in which the value of the objective function becomes higher (or smaller) is extracted, and the original shape function is adjusted. That is, the shape function is re-defined by finely adjusting variables included in the shape function based on a candidate shape determined to be preferable at that time. Then, it is advanced in a direction in which the value of the objective function becomes larger (or smaller) by using the shape function in the subsequent shape deriving step and the subsequent optimization step.

Such an optimization step can be executed by using a genetic algorithm (GA), a covariance matrix adaptation evolution strategy (CMA-ES), and the like.

The optimization step is repeatedly executed until a predetermined end condition is satisfied. Here, the end condition is, for example, a condition indicating that the number of cycles from the shape deriving step to the optimization step reaches a predetermined number, or a condition indicating that a state in which a change amount of values of the objective function is less than a reference value continues a predetermined number of times. Through such an optimization step, a core cross-sectional shape suitable for the preset objective condition is finally determined.

As described above, in order to obtain a desirable core cross-sectional shape in the shape deriving step, how to define the shape function is very important. Hereinafter, this point will be described, and an example using a normalized Gaussian network (NGnet), which is a known technique, will be described first in order to make the understanding of the present design method deeper, and then the present design method will be described.

In the present embodiment, a position and a size of the permanent magnet 34 (magnet arrangement region 44) are set in advance and included in an initial condition.

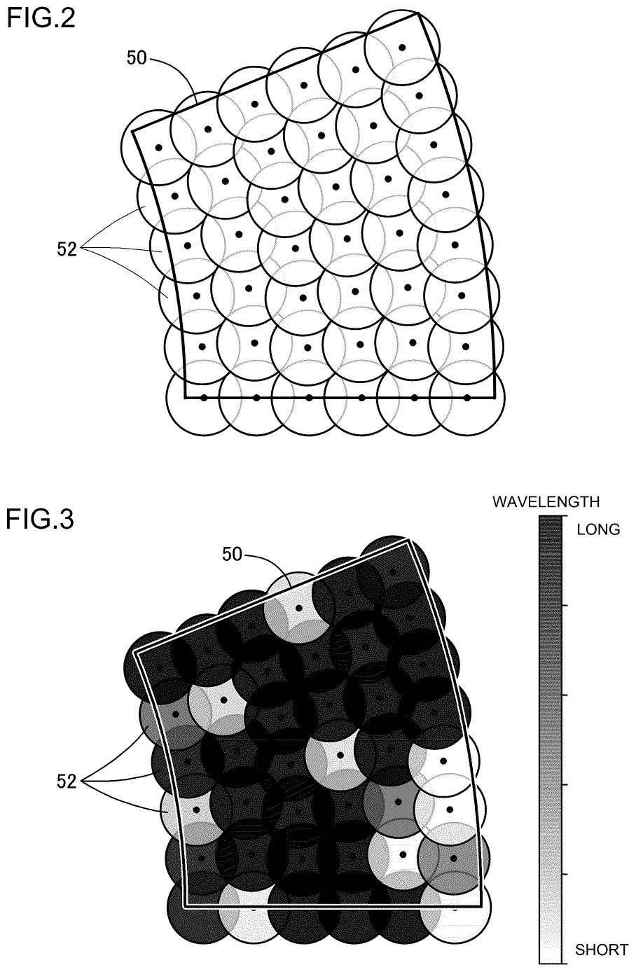

In an example using NGnet (hereinafter referred to as an “NGnet method”), first, a plurality of Gaussian bases 52 are arranged in the design target region 50 in a manner of being densely filled in the design target region 50 as illustrated in FIG. 2. Then, a normalized Gaussian function that spatially changes smoothly is assigned to each of the plurality of Gaussian bases 52, and the shape function is defined by superimposing the normalized Gaussian function. Specifically, a shape function y(x, w) is defined by the following formula.

$$y ( x , w ) = {\sum }_{i = 1}^{N} {w}_{i} {b}_{i} ( x ) {b}_{i} ( x ) = \frac{{G}_{i} ( x )}{{\sum }_{k = 1}^{N} {G}_{k} ( x )} \\ {G}_{k} ( x ) = \frac{1}{{( 2 π )}^{D / 2} {\vert {\sum }_{k} \vert}^{1 / 2}} exp [ - \frac{1}{2} {( x - {μ}_{k} )}^{T} {\sum }_{k}^{- 1} ( x - {μ}_{k} ) ] \qquad Math . 1$$

Here, N is the number of Gaussian functions, D is a dimension of an input x, μₖ and Σₖ are center vectors of a Gaussian function k and a covariance matrix, and wᵢ is a coupling weight of a normalized Gaussian function bᵢ(x).

A material type is assigned to each cell according to the following formula by using this shape function y(x, w).

$${M}_{e} = \{ \begin{matrix}iron , & y ( x ) \geq 0 \\ air , & y ( x ) < 0\end{matrix} \qquad Math . 2$$

Candidates for the core cross-sectional shape were derived according to these formulas, and then the core cross-sectional shape was optimized by the optimization step. In the present embodiment, for example, optimization is performed under an objective condition of increasing an outputtable torque and reducing a torque ripple. In this example, a priority is given to increasing the outputtable torque. Specifically, an objective function F(p, θₑ) was determined as follows, and an analysis was performed to minimize the objective function.

$$F ( p , {θ}_{e} ) = - \frac{{T}_{avg} ( p , {θ}_{e} )}{{T}_{avg}^{*}} + 0.2 \frac{{T}_{rip} ( p , {θ}_{e} )}{{T}_{rip}^{*}} {min}_{p , {θ}_{e}} F ( p , {θ}_{e} ) \qquad Math . 3$$

Here, Tₐᵥₑ(p, θₑ) is an average torque of an optimization model, T′ₐᵥₑ is an average torque of a reference model, Tᵣᵢₚ(p, θₑ) is a torque ripple of the optimization model, and T′ᵣᵢₚ is a torque ripple of the reference model. Further, p is a design variable of a topology optimization method, and θₑ is a design variable of an initial electrical angle.

The calculation of the objective function for optimizing the core cross-sectional shape may be performed for a shape of one of the design target regions 50, or may be performed for a shape of one magnetic pole in which two of the design target regions 50 face each other. Alternatively, the plurality of design target regions 50 may be coupled in the peripheral direction, and the calculation of the objective function may be performed for an overall shape of the rotor core 32.

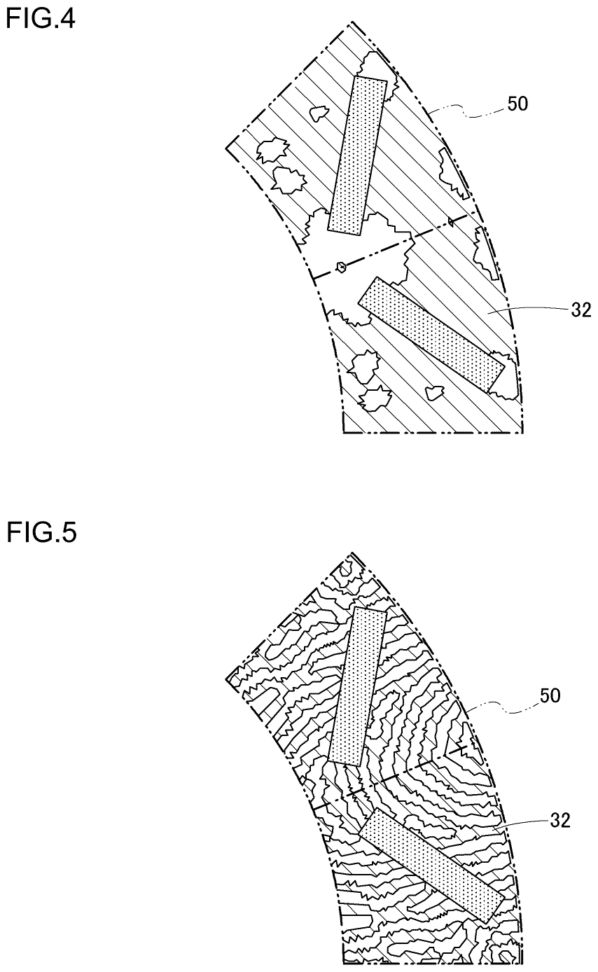

FIG. 4 illustrates a core cross-sectional shape optimized by the NGnet method as a comparative example. In the NGnet method, although a smooth shape is formed, it can be seen that a global shape is formed because on/off determination is performed on a uniform Gaussian base function distribution. Therefore, the NGnet method is not suitable for designing a shape of the rotor core 32 of the embedded magnet synchronous motor 1 that utilizes not only a torque generated by a magnetic flux of the permanent magnet 34 (hereinafter referred to as a “magnet torque”) but also a torque generated by a current flowing through the coils 26 (hereinafter referred to as a “reluctance torque”).

Therefore, the inventors focused on a Gabor filter capable of performing on/off determination along a flow of a magnetic flux, and attempted to effectively utilize the reluctance torque by defining a shape function using the Gabor filter (hereinafter, referred to as a “Gabor filter method”).

In the Gabor filter method, first, a plurality of Gaussian bases 52 are arranged in the design target region 50 in a manner of being densely filled in the design target region 50 (see FIG. 2), which is similar to the NGnet method described above. Thereafter, a Gabor filter is assigned to each of the plurality of Gaussian bases 52, and the shape function is defined by superimposing the Gabor filters in the Gabor filter method. Specifically, a shape function f(x, w, θ) is defined by the following formula.

$$f ( x , w , θ ) = {\sum }_{í = 1}^{N} {w}_{i} g ( x , {θ}_{i} ) g ( x , {θ}_{i} ) = {b}_{i} ( x ) cos [ \frac{2 π}{λ} ( {X}_{i} cos {θ}_{i} + {Y}_{i} sin {θ}_{i} ) ] \qquad Math . 4$$

Here, N is the number of Gabor filters, and wᵢ is a coupling weight of a Gabor filter g(x, θᵢ). bᵢ(x) is a normalized Gaussian function and is the same as that used in the NGnet method described above. λ is a wavelength, (Xᵢ, Yᵢ)=(x−xᵢ, y−yᵢ) is a position vector of a Gabor filter, θᵢ is a rotation angle of a Gabor filter, and (xᵢ, yᵢ) is center coordinates of a Gaussian base.

A material type is assigned to each cell according to the following formula by using the shape function f(x, w, θ).

$${M}_{e} = \{ \begin{matrix}iron , & f ( x , w , θ ) \geq 0 \\ air , & f ( x , w , θ ) < 0\end{matrix} \qquad Math . 5$$

Candidates for the core cross-sectional shape were derived according to these formulas, and then the core cross-sectional shape was optimized in the optimization step. The optimization was performed under the same condition as that in the case of the NGnet method described above.

FIG. 5 illustrates a core cross-sectional shape optimized by the Gabor filter method. In the Gabor filter method, it is suggested that a fine slit shape along a magnetic flux line caused by a current flowing through the coils 26 is obtained, and the reluctance torque can be sufficiently utilized. On the other hand, since the core and the gaps are alternately arranged around the permanent magnets 34, the magnet torque cannot be sufficiently utilized, and as a result, a motor feature may not be sufficiently improved.

In order to solve the above problem, the Gabor filter method in an initial stage of discussion (hereinafter referred to as a “basic Gabor filter method” for distinction, and this method is also used as a comparative example) is improved by the present design method. Hereinafter, the present design method is referred to as an “improved Gabor filter method”.

In the improved Gabor filter method, first, a plurality of Gaussian bases 52 are arranged in the design target region 50 in a manner of being densely filled in the design target region 50, which is similar to the NGnet method and the basic Gabor filter method described above. Thereafter, the shape function is defined by superimposing Gabor filters at wavelengths individually set for the plurality of Gaussian bases 52 in the improved Gabor filter method. Specifically, a shape function f(x, w, θ, λ) is defined by the following formula.

$$f ( x , w , θ , λ ) = {\sum }_{í = 1}^{N} {w}_{i} g ( x , {θ}_{i} , {λ}_{i} ) \\ g ( x , {θ}_{i} , {λ}_{i} ) = {b}_{i} ( x ) cos [ \frac{2 π}{{λ}_{i}} ( {X}_{i} cos {θ}_{i} + {Y}_{i} sin {θ}_{i} ) ] \qquad Math . 6$$

Here, N is the number of Gabor filters, and wᵢ is a coupling weight of a Gabor filter g(x, θᵢ). bᵢ(x) is a normalized Gaussian function and is the same as that used in the NGnet method described above. λᵢ is a wavelength, (Xᵢ, Yᵢ)=(x−Xᵢ, y−yᵢ) is a position vector of a Gabor filter, θᵢ is a rotation angle of a Gabor filter, and (xᵢ, yᵢ) is center coordinates of a Gaussian base.

While λ in the basic Gabor filter method is a fixed wavelength and is a constant, it is emphasized that λᵢ in the improved Gabor filter method is a wavelength individually set for each of the Gaussian bases 52 and is a variable. In FIG. 3, the magnitude of the wavelength set for each Gaussian base 52 is expressed by a density of a color attached to each Gaussian base 52.

A material type is assigned to each cell according to the following formula by using the shape function f(x, w, θ, λ).

$${M}_{e} = \{ \begin{matrix}iron , & f ( x , w , θ , λ ) \geq 0 \\ air , & f ( x , w , θ , λ ) < 0\end{matrix} \qquad Math . 7$$

Candidates for the core cross-sectional shape were derived according to these formulas, and then the core cross-sectional shape was optimized in the optimization step. The optimization was performed under the same condition as that in the case of the NGnet method and the basic Gabor filter method described above.

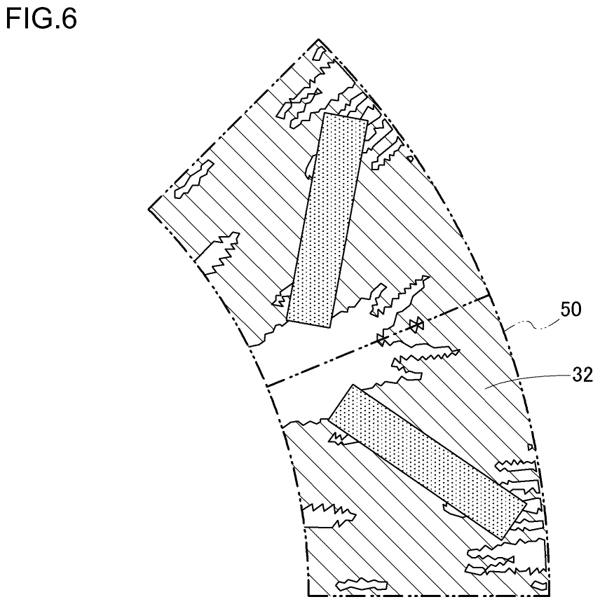

FIG. 6 illustrates a core cross-sectional shape optimized by the improved Gabor filter method as an embodiment. In the improved Gabor filter method, it can be seen that both a global shape similar to that obtained by the NGnet method serving as a first comparative example and a fine slit shape similar to that obtained by the basic Gabor filter method serving as a second comparative example are obtained. Since the global shape is formed around a magnetization plane of the permanent magnet 34, it is presumed that the magnet torque can be sufficiently utilized. In addition, since the fine slit shape for adjusting a flow of a magnetic flux caused by a current flowing through the coils 26 is formed in the vicinity of an end portion of the permanent magnet 34 or at a position away from the permanent magnet 34, it is presumed that the reluctance torque can be sufficiently utilized. In this manner, the present design method using the improved Gabor filter method can effectively use both the magnet torque and the reluctance torque, and can form the rotor core 32 of the embedded magnet synchronous motor 1 having high performance.

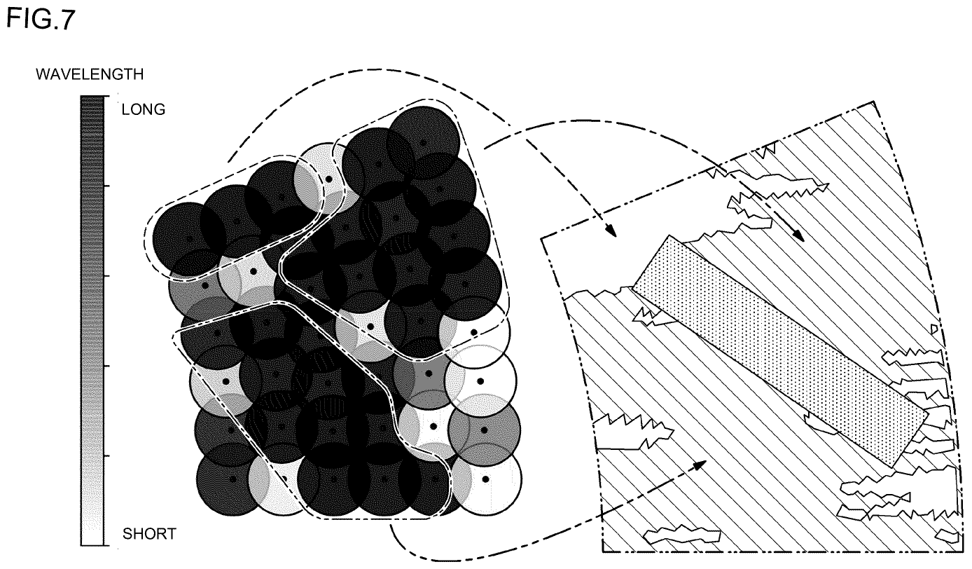

FIG. 7 illustrates an optimized core cross-sectional shape and a wavelength of a Gabor filter for each Gaussian base 52 in the original shape function. From this figure, it was confirmed that a global shape was formed regardless of whether the Gabor filter was a core or a gap in a region where the wavelength of the Gabor filter was long, and a fine slit shape was formed in a region where the wavelength of the Gabor filter was short. In the present design method (improved Gabor filter method), a wavelength of a Gabor filter can be individually set for each Gaussian base 52, and a shape of the rotor core 32 of the embedded magnet synchronous motor 1 can be suitably designed by optimizing the wavelength.

In the present design method using the improved Gabor filter method, further improvement can be achieved according to a setting of the objective condition in the optimization step.

For example, when the objective condition includes further increasing a torque density on the premise that the outputtable torque is increased, it is conceivable to separately evaluate the magnet torque and the reluctance torque in the optimization step. More specifically, first, a current is caused to flow through the coil 26 of the stator 20, and a magnetic field analysis is performed in a state where both the stator 20 and the rotor 30 are excited together with the permanent magnet 34. Thereafter, obtained magnetic permeability is fixed, and the analysis is performed by exciting only one of the stator 20 and the rotor 30, so that an influence of each magnetomotive force source (that is, the magnet torque and the reluctance torque) can be individually evaluated.

It is possible to incorporate terms related to the magnet torque and the reluctance torque into the objective function by individually obtaining the magnet torque and the reluctance torque. In the example described above, in addition to a term of the outputtable torque, for example, the reluctance torque can be further increased on the premise that the total outputtable torque is increased, by incorporating a term of the reluctance torque alone into the objective function. It is possible to output the same level of total torque while reducing the size of the rotor 30 by increasing the contribution of the reluctance torque. As a result, a torque density can be increased.

For example, when the objective condition includes improvement of a strength against a centrifugal force (hereinafter, referred to as a “centrifugal stress”), it is conceivable to perform mesh division on the design target region 50, which is a basic setting of the shape deriving step or the optimization step, based on the shape function. An example illustrated in FIG. 8 is an example of general mesh division (fixed mesh), and a core cross-sectional shape (boundary between a core and a gap) derived in the shape deriving step is uneven depending on a shape of the mesh 54. In such an uneven shape, there are many singular points, and the calculation accuracy of the centrifugal stress may decrease in a structural analysis.

Therefore, in such a case, in order to divide the design target region 50 into meshes, as illustrated in FIG. 9, it is effective to create the meshes 54 such that any one mesh boundary is arranged along an isosurface 60 of the shape function. In particular, it is preferable to create the meshes 54 such that any one mesh boundary is arranged along the isosurface 60 (zero isosurface) where the value of the shape function is zero. Since the zero isosurface of the shape function is a reference surface for assigning a material type to each cell, the core cross-sectional shape (boundary between the core and the gap) derived in the shape deriving step can be smoothed by creating the meshes 54 such that a mesh boundary is along the zero isosurface. Accordingly, the centrifugal stress can be accurately calculated in the structural analysis, and the centrifugal stress of the rotor core 32 can be appropriately improved.

### OTHER EMBODIMENTS

(1) A configuration is described in the above embodiment as an example in which the position and the size of the permanent magnet 34 (magnet arrangement region 44) are set in advance. However, this disclosure is not limited to such a configuration, the position and the size of the permanent magnet 34 may be variable, and a core cross-sectional shape including the position and the size of the magnet arrangement region 44 may be designed. In this case, the shape function can be defined by a combination of two types of functions using a Gabor filter, and three material types (core, magnet, gap) can be assigned based on a combination of positive and negative outputs of the shape function.

(2) In this case, a configuration of a magnetic pole formed by the permanent magnet 34 can be changed. For example, one magnetic pole may be formed of two types of permanent magnets 34 having magnetization planes oriented in different directions in consideration of symmetry. In such a case, the shape function is defined by a combination of two types of functions using a Gabor filter, and four material types (core, magnet 1, magnet 2, gap) are assigned based on a combination of positive and negative outputs of the shape function, so that the core cross-sectional shape can be designed.

(3) A configuration is described in the above embodiment as an example in which only the objective condition is set and the core cross-sectional shape suitable for the objective condition is determined in the optimization step. However, this disclosure is not limited to such a configuration, and for example, a constraint condition may be set in the optimization step in addition to the objective condition. In this case, processing of excluding a candidate shape corresponding to the constraint condition may be executed. For example, when the core cross-sectional shape including the position and the size of the magnet arrangement region 44 is designed, from the viewpoint of practicality, a shape and a size of the magnet arrangement region 44 may be restricted such that a cross-sectional shape is rectangular or has a realistic dimension.

(4) A configuration is described in the above embodiment as an example in which one magnetic pole is formed by a pair of two permanent magnets 34 arranged in a V-shape. However, this disclosure is not limited to such a configuration, and the set of two permanent magnets 34 may be arranged vertically or horizontally parallel to each other. One magnetic pole may be implemented by one permanent magnet 34 in a vertical arrangement or a horizontal arrangement, or may be implemented by a combination of three or more permanent magnets 34 in any arrangement form.

(5) The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

### Overview of Embodiments

In summary, a rotor core design method according to the disclosure preferably includes the following configurations.

A rotor core design method for designing a shape of the rotor core (32) including the magnet arrangement region (44) where a permanent magnet (34) is arranged and the flux barrier region (46) that limits a flow of a magnetic flux, the rotor core design method including:
when determining a core cross-sectional shape, which is a shape of a cross section orthogonal to the rotation axis (X) of the rotor core (32), by topology optimization using a finite element method,
arranging the plurality of Gaussian bases (52) in the design target region (50), and defining a shape function by superimposing Gabor filters at wavelengths individually set for the plurality of Gaussian bases (52); and
determining the core cross-sectional shape satisfying a preset objective condition by using the shape function according to an optimization algorithm.

According to this configuration, it is possible to perform on/off determination along a flow of a magnetic flux, and express a fine slit shape by defining the shape function using the Gabor filters. In this case, an optimum wavelength can be set for each Gaussian base (52) by applying the Gabor filters corresponding to the plurality of Gaussian bases (52) at the wavelengths individually set for the Gaussian bases (52). As a result, both a global shape and a fine shape can be obtained. Therefore, the rotor core (32) including the magnet arrangement region (44) and the flux barrier region (46) for the embedded magnet synchronous motor can be smoothly formed as a whole while having a fine slit shape by designing a shape of the rotor core (32) according to the present design method.

In an aspect,
the rotor core (32) is preferably disposed to face the stator (20) including the coil (26),
the objective condition preferably includes increasing an outputtable torque, and
in the optimization algorithm, a torque caused by a magnetic flux of the permanent magnet (34) and a torque caused by a current flowing through the coil (26) are preferably separately evaluated.

According to this configuration, it is possible to determine the core cross-sectional shape so as to preferentially increase either the torque caused by the magnetic flux of the permanent magnet (34) or the torque caused by the current flowing through the coil (26) while basically increasing a total outputtable torque.

In another aspect,
the objective condition preferably includes improving a strength against a centrifugal force, and
in the finite element method, when the design target region (50) is divided into meshes, the plurality of meshes (54) are preferably created such that any one mesh boundary is arranged along the isosurface (60) of the shape function.

According to this configuration, since the boundary between different materials derived according to positive and negative outputs of the shape function is smoothed, the strength against the centrifugal force can be accurately calculated in the optimization algorithm. Therefore, the core cross-sectional shape can be more appropriately determined to improve the strength against the centrifugal force.

The rotor core design method according to the present disclosure may obtain at least one of the above-described effects.

The present specification also discloses the rotor core (32) having a core cross-sectional shape determined by any one of the rotor core design methods described above.

The present specification also discloses a rotor core design device for implementing any one of the rotor core design methods described above. Such a rotor core design device may include a functional unit that executes the design target region setting step, a functional unit that executes the mesh forming step, a functional unit that executes the shape deriving step, and a functional unit that executes the optimization step. Each of these functional units may be included in a single information processing device, or may be distributed and included in a plurality of information processing devices capable of communicating with one another via a network.

What is claimed is:

1. A rotor core design method for designing a shape of a rotor core including a magnet arrangement region where a permanent magnet is arranged and a flux barrier region that limits a flow of a magnetic flux, the rotor core design method comprising:
when determining a core cross-sectional shape, which is a shape of a cross section orthogonal to a rotation axis of the rotor core, by topology optimization using a finite element method,
arranging a plurality of Gaussian bases in a design target region, and defining a shape function by superimposing Gabor filters at wavelengths individually set for the plurality of Gaussian bases; and
determining the core cross-sectional shape satisfying a preset objective condition by using the shape function according to an optimization algorithm.

2. The rotor core design method according to claim 1, wherein
the rotor core is disposed to face a stator including a coil,
the objective condition includes increasing an outputtable torque, and
in the optimization algorithm, a torque caused by a magnetic flux of the permanent magnet and a torque caused by a current flowing through the coil are separately evaluated.

3. The rotor core design method according to claim 1, wherein
the objective condition includes improving a strength against a centrifugal force, and
in the finite element method, when the design target region is divided into meshes, the meshes are created such that any one mesh boundary is arranged along an isosurface of the shape function.

4. A rotor core having the core cross-sectional shape determined by the rotor core design method according to claim 1.

5. A rotor core having the core cross-sectional shape determined by the rotor core design method according to claim 2.

6. A rotor core having the core cross-sectional shape determined by the rotor core design method according to claim 3.
